(19) United States
(12) Patent Application Publication
(10) Pub. No.: US 2016/0252212 A1
(43) Pub. Date: Sep. 1, 2016

(54) CRYOGENIC TANK

(71) Applicant: IHI Corporation, Tokyo (JP)

(72) Inventors: Ryuzo KANNO, Tokyo (JP); Michitaka FURIKOMA, Tokyo (JP); Eiji KAMIYA, Tokyo (JP)

(73) Assignee: IHI Corporation, Tokyo (JP)

(21) Appl. No.: 15/150,195

(22) Filed: May 9, 2016

Related U.S. Application Data
(63) Continuation of application No. PCT/JP2014/078982, filed on Oct. 30, 2014.

(30) Foreign Application Priority Data
Nov. 15, 2013 (JP) 2013-236944

(51) Int. Cl. F17C 13/00

(52) U.S. Cl. CPC F17C 13/001; F17C 2203/03; F17C 2223/0161; F17C 2201/0128; F17C 2203/012; F17C 2203/0604

(57) ABSTRACT

A cryogenic tank includes a membrane anchor mechanism which fixes a membrane provided on an inner wall surface side of a concrete wall via a heat insulating material to the concrete wall, a pressing par which is provided by the membrane anchor mechanism and presses the membrane from the inside of the cryogenic tank, and an interposition part which is interposed between the pressing part of the membrane anchor mechanism and the membrane, and includes a first abutment surface coming into surface-contact with the pressing part and a second abutment surface coming into surface-contact with the membrane.

This application is a continuation application based on a PCT Patent Application No. PCT/JP2014/078982, filed on Oct. 30, 2014, whose priority is claimed on Japanese Patent Application No. 2013-236944, filed on Nov. 15, 2013. The contents of both the PCT Application and the Japanese Application are incorporated herein by reference.

### TECHNICAL FIELD

The present embodiments described herein relate to a cryogenic tank.

### BACKGROUND

In the related art, in a membrane type cryogenic tank including a membrane in which a plurality of membrane panels are welded, in order to maintain a shape of a thin membrane having low stiffness, a configuration which is supported to be pressed to a concrete wall via a heat insulating material by a membrane anchor mechanism is used (for example, refer to Japanese Examined Patent Application, Second Publication No. S63-23440). As the membrane type cryogenic tank, tanks having various shapes are used, and for example, a tank which is formed to have a square corner portion, a cylindrical corner portion, or the like is also used widely. In Japanese Unexamined Patent Application, First Publication No. 2009-79736, a membrane anchor mechanism which supports a membrane panel (corner membrane panel) installed in a corner portion of a cryogenic tank is disclosed. The membrane anchor mechanism disclosed in Japanese Unexamined Patent Application, First Publication No. 2009-79736 is installed at a boundary portion of a haunch structural portion provided on a corner portion, and supports an edge portion of the corner membrane panel.

### SUMMARY

However, the above-described haunch structure is not necessarily provided on all cryogenic tanks having the corner portion. Accordingly, the membrane anchor mechanism disclosed in Japanese Unexamined Patent Application, First Publication No. 2009-79736 cannot be adopted with respect to all cryogenic tanks. Moreover, in the membrane anchor mechanism in which the support location is limited to the edge of the corner membrane panel, for example, disposition in which a center of the membrane panel is pressed cannot be performed.

Therefore, a configuration which includes a pressing part by which the membrane anchor mechanism presses the membrane from the inside of the cryogenic tank and presses an arbitrary position of the membrane is considered. However, when a surface of the membrane on which the pressing part is installed is not flat, the pressing part and the membrane do not come into surface-contact with each other, and sealing between the pressing part and the membrane is likely to be decreased.

The present disclosure is made in consideration of the above-described problems, and an object thereof is to prevent sealing between the pressing part and the membrane from being decreased when the membrane anchor mechanism includes the pressing part which presses the membrane from the inside of the cryogenic tank.

The present disclosure adopts the following configurations as means for solving the above-described problems.

According to a first aspect of the present disclosure, there is provided a cryogenic tank, including: a membrane anchor mechanism which fixes a membrane provided on an inner wall surface side of a concrete wall via a heat insulating material to the concrete wall; a pressing part which is provided by the membrane anchor mechanism and presses the membrane from the inside of the cryogenic tank; and an interposition part which is interposed between the pressing part of the membrane anchor mechanism and the membrane, and includes a first abutment surface coming into surface-contact with the pressing part and a second abutment surface coming into surface-contact with the membrane.

According to the present disclosure, the interposition part which is interposed between the pressing part of the membrane anchor mechanism and the membrane is provided, and the interposition part includes the first abutment surface coming into surface-contact with the pressing part and the second abutment surface coming into surface-contact with the membrane. Accordingly, even when the membrane has any shape, the interposition part abuts the pressing part and the membrane to come into surface-contact with both. Therefore, it is possible to prevent a decrease in sealing between the pressing part and the membrane.

### BRIEF DESCRIPTION OF THE DRAWINGS

FIG. 1 is a cross-sectional perspective view showing a cryogenic tank according to an embodiment of the present disclosure.

FIG. 2 is a cross-sectional view showing a two-surface corner portion including a two-surface corner membrane anchor mechanism which is included in the cryogenic tank according to the embodiment of the present disclosure.

FIG. 3A is a plan view which shows the two-surface corner membrane anchor mechanism except for a leg portion and a pressing part included in the cryogenic tank according to the embodiment of the present disclosure when viewed in a direction along an axis of an anchor.

FIG. 3B is a side view when the two-surface corner membrane anchor mechanism shown in FIG. 3A is viewed in a direction orthogonal to the direction along the axis of the anchor.

FIG. 3C is a view when the two-surface corner membrane anchor mechanism shown in FIG. 3B is viewed from arrow A.

FIG. 4A is a plan view showing the pressing part included in the cryogenic tank according to the embodiment of the present disclosure.

FIG. 4B is a side view showing the pressing part shown in FIG. 4A.

FIG. 5A is a plan view showing a spacer included in the cryogenic tank according to the embodiment of the present disclosure.

FIG. 5B is a cross-section view taken along line A-A of the spacer shown in FIG. 5A.

FIG. 5C is a view when the spacer shown in FIG. 5A is viewed from arrow B.

### DETAILED DESCRIPTION OF THE DISCLOSURE

Hereinafter, an embodiment of a cryogenic tank according to the present disclosure will be described with reference to the drawings. Moreover, in the following drawings, in order to allow each member to be a recognizable size, the scale of each member is appropriately changed.

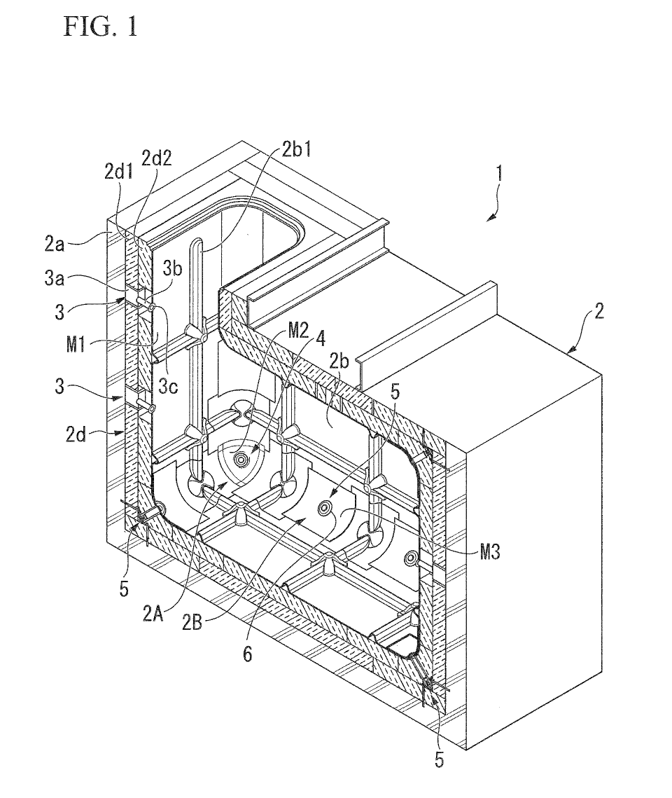

FIG. 1 is a cross-sectional perspective view showing a cryogenic tank 1 of the present embodiment. The cryogenic tank 1 of the present embodiment includes a container main body 2, a plane membrane anchor mechanism 3, a three-surface corner membrane anchor mechanism 4, a two-surface corner membrane anchor mechanism 5, and a spacer 6 (interposition part).

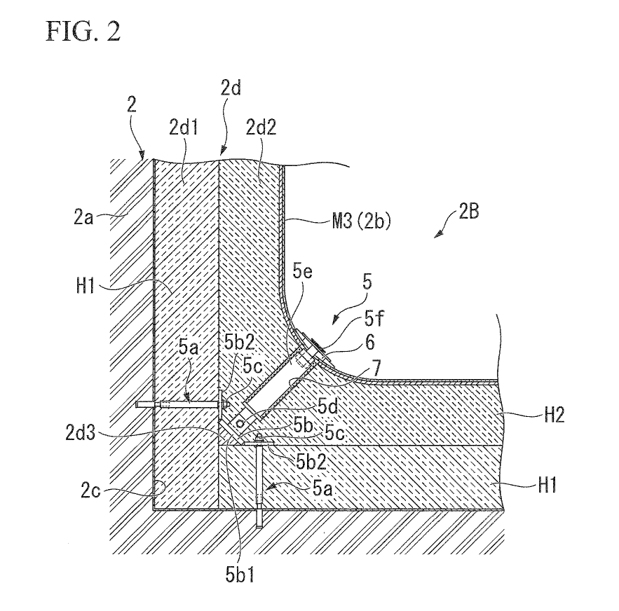

The container main body 2 is a rectangular container which includes a concrete wall 2a forming an outer tank, a membrane 2b forming an inner tank, a vapor barrier 2c (refer to FIG. 2) stuck to an inner wall surface of the concrete wall 2a, and a cold insulating material layer 2d installed between the vapor barrier 2c and the membrane 2b.

The concrete wall 2a is a wall portion formed of concrete which forms an outer shell of the container main body 2 and a strength member which supports the membrane 2b or the like. The membrane 2b is a portion which directly comes into contact with a cryogenic liquid (for example, liquefied argon) stored in an inner portion of the tank, and is installed on the inner wall surface side of the concrete wall 2a via the cold insulating material layer 2d. A corrugation 2b1 which vertically and horizontally extends in a lattice shape and absorbs thermal deformation of the membrane 2b is provided on the membrane 2b. For example, the membrane 2b is formed by welding a sheet shaped membrane panel which is formed of stainless steel and has a thickness of several millimeters.

Since the container main body 2 is formed in a rectangular shape, the container main body 2 includes a corner portion (hereinafter, referred to as a three-surface corner portion 2A) formed at a location at which three surfaces (for example, two side wall surfaces and a bottom surface, or two side wall surfaces and a top surface) are collected, and a corner portion (hereinafter, referred to as a two-surface corner portion 2B) formed at a location at which two surfaces (for example, the side wall surface and the bottom surface, the side wall surfaces, or the side wall surface and the top surface) are collected. The membrane panel which is disposed on the corner portions is curved according to the shapes of the corner portions. Hereinafter, the membrane panel on a plane which is disposed on a region other than the corner portions is referred to as a plane membrane panel M1, the membrane panel which is disposed on the three-surface corner portion 2A is referred to as a three-surface corner membrane panel M2 (corner membrane panel), and the membrane panel which is disposed on the two-surface corner portion 2B is referred to as a two-surface corner membrane panel M3.

The vapor barrier 2c is a metal sheet member which is stuck to the entire region of the inner wall surface of the concrete wall 2a. The vapor barrier 2c blocks water or the like passing through the concrete wall 2a and improve airtightness of the container main body 2.

The cold insulating material layer 2d includes an outer layer portion 2d1, an inner layer portion 2d2, and a filling portion 2d3 (refer to FIG. 2). The outer layer portion 2d1 is a layer which forms the concrete wall 2a side of the cold insulating material layer 2d, and is formed by laying cold insulating panels H1 having the same thickness without a gap. The inner layer portion 2d2 is a layer which forms the membrane 2b side of the cold insulating material layer 2d, and is formed by laying cold insulating panels H2 having the same thickness without a gap. The filling portion 2d3 is a portion which is filled with respect to a gap generated when the outer layer portion 2d 1 and the inner layer portion 2d2 are laid, and has a shape coincident with the shape of the installed gap. For example, the filling portion 2d3 is filled in a gap which is formed between a base portion 5b and an outer layer portion 2d1 of the two-surface corner membrane anchor mechanism 5 described below.

For example, the cold insulating material layer 2d is formed of Poly Urethane Foam (PUF), and the gap between the membrane 2b and the concrete wall 2a to which the vapor barrier 2c is stuck is filled with the cold insulating layer.

A through-hole 7 which is disposed at a center position in the thermal deformation part of each membrane panel is provided on the membrane 2b and the cold insulating material layer 2d. An anchor 3b of the plane membrane anchor mechanism 3, an anchor of the three-surface corner membrane anchor mechanism 4, or an anchor 5e of the two-surface corner membrane anchor mechanism 5 is inserted into the through-hole 7.

The plane membrane anchor mechanism 3 includes a base 3a which is provided on the inner wall surface of the concrete wall 2a via the vapor barrier 2c, the anchor 3b which is fixed to the base 3a and is inserted into the through-hole 7, and a pressing part 3c which is fixed to the anchor 3b exposed from the through-hole 7 and presses the plane membrane panel M1 from the inner portion side of the container main body 2 toward the concrete wall 2a.

The three-surface corner membrane anchor mechanism 4 includes a leg portion which is provided on the three-surface corner portion 2A and is provided on each of the three surfaces forming the three-surface corner portion 2A, an anchor which is fixed to the leg portion and is inserted into the through-hole 7, and a pressing part which is fixed to the anchor exposed from the through-hole 7 and presses the three-surface corner membrane panel M2 from the inner portion side of the container main body 2 toward the concrete wall 2a.

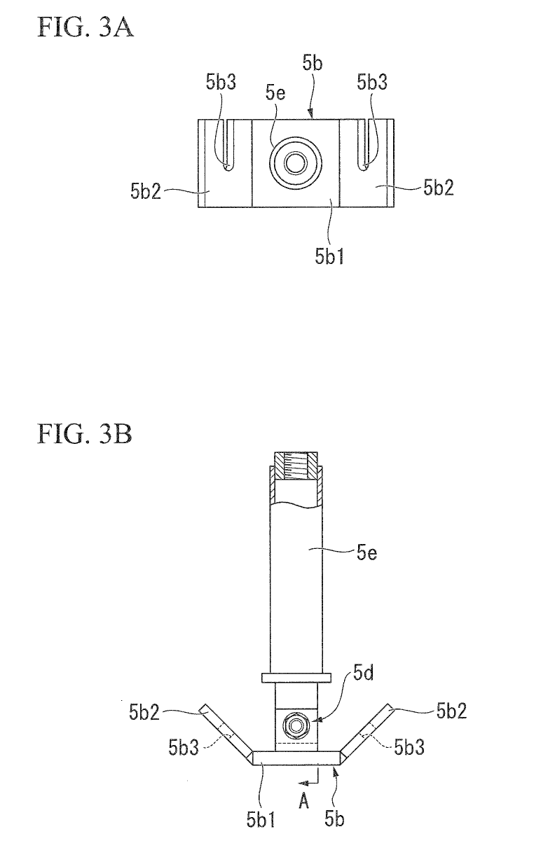

FIG. 2 is a cross-sectional view showing the two-surface corner portion 2B including the two-surface corner membrane anchor mechanism 5. In addition, FIGS. 3A to 3C are views showing the two-surface corner membrane anchor mechanism 5 except for the leg portion 5a and the pressing part 5f, of which FIG. 3A is a plan view when the two-surface corner membrane anchor mechanism 5 is viewed in a direction along an axis of the anchor 5e, FIG. 3B is a side view when the two-surface corner membrane anchor mechanism 5 is viewed in a direction orthogonal to the direction along the axis of the anchor 5e, and FIG. 3C is a view when the two-surface corner membrane anchor mechanism 5 is viewed from arrow A of FIG. 3B.

As shown in the drawings, the two-surface corner membrane anchor mechanism 5 includes a leg portion 5a which is provided on the two-surface corner portion 2B and is provided on each of the two surfaces forming the two-surface corner portion 2B, a base portion 5b, a nut 5c, a joint 5d, the anchor 5e, and the pressing part 5f.

The leg portion 5a is a rod-shaped member which extends in the direction perpendicular to the inner wall surface of the concrete wall 2a, and is erected to the concrete wall 2a via the vapor barrier 2c. The leg portion 5a includes a first stud bolt which is formed on one end portion of the concrete wall 2a side, a second stud bolt which is formed on one end portion of the base portion 5b side, and a long nut which forms a center portion of the leg portion. A length of the leg portion 5a except for the second stud bolt is approximately the same as the thickness in the outer layer portion 2d1 of the cold insulating material layer 2d.

The base portion 5b is a portion to which two leg portions 5a or the anchor 5e is attached, and is provided at a position at which the second stud bolts of two leg portions 5a approach each other. The base portion 5b includes a center plate 5b1 on which the anchor 5e is installed via the joint 5d, and two leg portion connection plates 5b2 which are provided on edge portions of the center plate 5b1 and to which the leg portions 5a are connected. Each leg portion connection plate 5b2 is attached to the center plate 5b1 at an angle formed to oppose each surface of the concrete wall 2a forming the two-surface corner portion 2B. The leg portion connection plate 5b2 is disposed at a position at which the outer layer portion 2d1 abuts the surface of the inner layer portion 2d2 side in the above-described cold insulating material layer 2d. Moreover, a notch portion 5b3 is provided on the leg portion connection plate 5b2. The second stud bolt of the leg portion 5a passes through the notch portion 5b3 and protrudes to the side on which the anchor 5e is installed.

The notch portion 5b3 has a shape, in which one end in the longitudinal direction is opened, with the extension direction of the two-surface corner portion 2B as the longitudinal direction. As shown in FIG. 3, the notch portions 5b3 provided on two leg portion connection plates 5b2 are opened in the same direction. According to the notch portion 5b3, it is possible to adjust the position of the anchor 5e attached to the base portion 5b in the extension direction of the notch portion 5b3 (that is, the extension direction of the two-surface corner portion 2B).

The nut 5c is screwed to the second stud bolt which protrudes from the notch portion 5b3 of the leg portion connection plate 5b2 to the anchor 5e side, and abuts the surface of the anchor 5e side in the leg portion connection plate 5b2 via a washer. The nuts 5c screwed to the second stud bolts of the leg portions 5a press the base portion 5b in different directions, and thus, the base portion 5b is fixed.

The joint 5d is attached to the center plate 5b1 of the base portion 5b and rotatably supports the anchor Se. The joint 5d is configured to include a bolt which extends in a horizontal direction orthogonal to the extension direction of the anchor 5e as an axial direction thereof, and a nut which is screwed to the bolt and rotatably interposes the anchor Se along with the bolt. Since the anchor 5e is supported by the joint 5d, the anchor 5e can rotate about the horizontal direction orthogonal to the extension direction of the anchor Se.

The anchor 5e is a cylindrical member which is long in an axial direction thereof, and screw grooves for attaching the pressing part 5f are formed on the inner wall surface of the tip portion of the anchor. In the anchor Se, the base portion of the anchor is attached to the center plate 5b1 of the base portion 5b via the joint 5d, and the tip of the anchor to which the pressing part 5f is fixed is inserted into the through-hole 7 to be exposed toward the inside of the container main body 2. The length of the anchor Se is approximately the same as the thickness of the inner layer portion 2d2 of the cold insulating material layer 2d. The anchor Se is supported by the base portion 5b, and thus, the anchor is supported in the state of being separated from the concrete wall 2a.

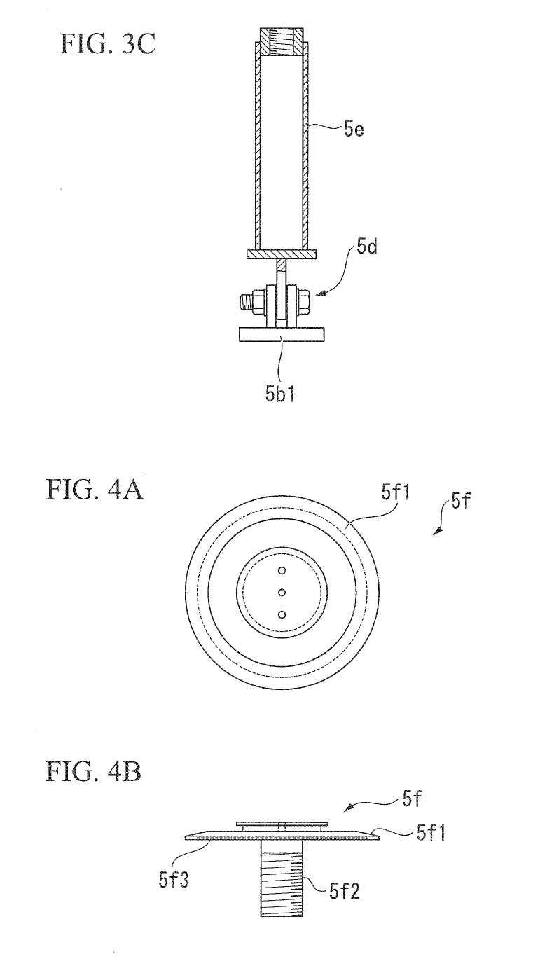

FIGS. 4A and 4B are views showing the pressing part 5f, of which FIG. 4A is a plan view of the pressing part, and FIG. 4B is a side view of the pressing part. As shown in these drawings, the pressing part 5f includes a disk-shaped main body 5f1 and a shaft portion 5f2 which is integrated with the main body 5f1. In the main body 5f1, the surface (hereinafter, referred to as an abutment surface 5f3) of the main body to which the shaft portion 5f2 is attached is formed in a plane. The shaft portion 5f2 is provided on the center portion of the main body 5f1 of the abutment surface 5f3 side, and is a columnar portion in which screw grooves are formed on the circumferential surface thereof. The shaft portion 5f2 is screwed to the anchor 5e. The shaft portion 5f2 is screwed to the anchor 5e to fasten the pressing part 5f, and thus, the main body 5f1 presses the two-surface corner membrane panel M3 toward the concrete wall 2a via the spacer 6, and the two-surface corner membrane panel M3 is fixed to the concrete wall 2a. In addition, the edge of the main body 5f1 of the pressing part 5f is fixed to the spacer 6 by welding.

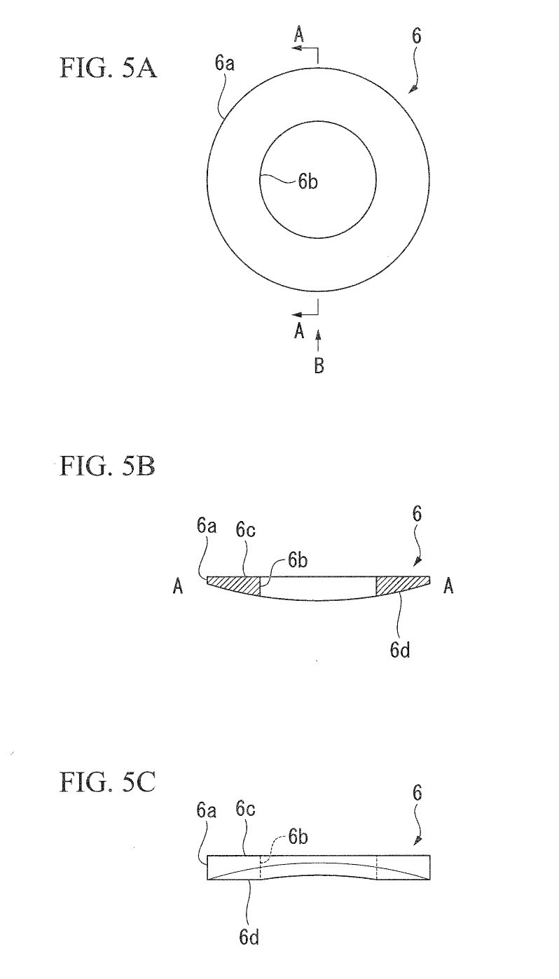

FIGS. 5A to SC are views showing the spacer 6, of which FIG. 5A is a plan view of the spacer, FIG. 5B is a cross-sectional view taken along line A-A of FIG. 5A, and FIG. 5C is a view when viewed from arrow B of FIG. 5A. An outer edge 6a of the spacer 6 is a circular shape, and the spacer is an approximately disk-shaped member having a circular opening 6b at the center portion of the spacer. Moreover, the spacer 6 is interposed between the pressing part 5f of the two-surface corner membrane anchor mechanism 5 and the two-surface corner membrane panel M3, and includes a pressing part abutment surface 6c (first abutment surface) which comes into surface-contact with the pressing part 5f, and a membrane abutment surface 6d (second abutment surface) which comes into surface-contact with the two-surface corner membrane panel M3.

The spacer 6 is disposed to surround the connection location between the anchor Se exposed from the through-hole 7 and the pressing part 5f screwed to the tip of the anchor Se. The pressing part abutment surface 6c is a region which comes into surface-contact with the abutment surface 5f3 of the pressing part 5f, and is formed in a plane to come into surface-contact with the abutment surface 5f3 of the pressing part 5f.

The membrane abutment surface 6d is a region which comes into surface-contact with the two-surface corner membrane panel M3, and is curved to match the surface of the two-surface corner membrane panel M3 to come into surface-contact with the two-surface corner membrane panel M3.

As described above, the spacer 6 is interposed between the pressing part 5f of the two-surface corner membrane anchor mechanism 5 and the two-surface corner membrane panel M3, and the outer edge 6a is welded to the two-surface corner membrane panel M3 and thus, is fixed to the membrane panel. Moreover, the outer edge of the pressing part 5f is welded to the pressing part abutment surface 6c.

According to the above-described cryogenic tank 1 of the present embodiment, the spacer 6 which is interposed between the pressing part 5f of the two-surface corner membrane anchor mechanism 5 and the two-surface corner membrane panel M3 is provided, and the spacer 6 includes the pressing part abutment surface 6c which comes into surface-contact with the pressing part 5f and the membrane abutment surface 6d which comes into surface-contact with the two-surface corner membrane panel M3. Accordingly, even when the membrane panel such as the two-surface corner membrane panel M3 has a curved shape, the spacer 6 abuts the pressing part 5f and the two-surface corner membrane panel M3 to come into surface-contact with both, and thus, it is possible to prevent a decrease of sealing between the pressing part 5f and the two-surface corner membrane panel M3.

Moreover, in the cryogenic tank 1 of the present embodiment, since the spacer 6 is interposed between the two-surface corner membrane panel M3 and the abutment surface 5f3 having the surface shapes different form each other in which the surface-contact is not easily performed, it is possible to use an advantage of the installation of the spacer 6 to the maximum.

In addition, in the cryogenic tank 1 of the present embodiment, the shape of the spacer 6 is set to an annular shape which is disposed to surround the connection location between the anchor 5e and the pressing part 5f of the two-surface corner membrane anchor mechanism 5. Before the pressing part 5f is screwed to the anchor 5e, the spacer 6 is disposed to surround the anchor 5e when viewed in the axial direction of the anchor 5e, and thereafter, the pressing part 5f is attached to the anchor 5e, and thus, it is possible to easily interpose the spacer 6 between the pressing part 5f and the two-surface corner membrane panel M3.

While preferred embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

For example, in the above-described embodiment, the configuration in which the spacer 6 is interposed between the pressing part 5f of the two-surface corner membrane anchor mechanism 5 and the two-surface corner membrane panel M3 is described.

However, the present disclosure is not limited to this, and it is possible to adopt a configuration which includes a spacer which is interposed between the plane membrane panel M1 and the pressing part 3c of the plane membrane anchor mechanism 3, or between the three-surface corner membrane panel M2 and the pressing part of the three-surface corner membrane anchor mechanism 4.

In addition, in the above-described embodiment, it is possible to adjust the position of the two-surface corner membrane anchor mechanism 5 in the extension direction of the two-surface corner portion 2B. Accordingly, for example, a configuration may be adopted in which the outer shape (the shape of the outer edge 6a) of the spacer 6 and the shape of the opening 6b are formed in elliptical shapes which are long in a direction (that is, in the extension direction of the two-surface corner portion 2B) in which the position of the anchor 5e can be adjusted. If this configuration is adopted, since the opening 6a is formed in an elliptical shape, it is possible to adjust the position of the two-surface corner membrane anchor mechanism 5 without changing the installation position of the spacer 6. In addition, similarly, since the outer shape of the spacer 6 is also formed in an elliptical shape, even when the positional relationship between the spacer 6 and the pressing part 5f is changed by adjusting the position of the two-surface corner membrane anchor mechanism 5, it is possible to sufficiently and widely secure the contact area between the spacer 6 and the pressing part 5f, and high sealing can be secured.

According to the present disclosure, when the membrane anchor mechanism includes the pressing part which presses the membrane from the inside of the cryogenic tank, a decrease in sealing between the pressing part and the membrane is prevented.

What is claimed is:

1. A cryogenic tank, comprising:
a membrane anchor mechanism which fixes a membrane provided on an inner wall surface side of a concrete wall via a heat insulating material to the concrete wall;
a pressing part which is provided by the membrane anchor mechanism and presses the membrane from the inside of the cryogenic tank; and
an interposition part which is interposed between the pressing part of the membrane anchor mechanism and the membrane, and includes a first abutment surface coming into surface-contact with the pressing part and a second abutment surface coming into surface-contact with the membrane.

2. The cryogenic tank according to claim 1,
wherein the membrane includes a corner membrane panel which is a curved membrane panel disposed at a corner portion of the tank formed by joining two surfaces, and
wherein the interposition part is installed between the pressing part of the membrane anchor mechanism and the membrane in the corner membrane panel.

3. The cryogenic tank according to claim 1,
wherein the membrane anchor mechanism includes an anchor which is inserted into a through-hole passing through the heat insulating material and the membrane and in which the pressing part is fixed to a tip exposed through the through-hole, and
wherein a shape of the interposition part is set to an annular shape which is disposed to surround a connection location between the anchor and the pressing part.

4. The cryogenic tank according to claim 2,
wherein the membrane anchor mechanism includes an anchor which is inserted into a through-hole passing through the heat insulating material and the membrane and in which the pressing part is fixed to a tip exposed through the through-hole, and
wherein a shape of the interposition part is set to an annular shape which is disposed to surround a connection location between the anchor and the pressing part.

5. The cryogenic tank according to claim 3,
wherein a position of the anchor of the membrane anchor mechanism can be adjusted, and
wherein an outer shape and a central opening of the interposition part are formed in elliptical shapes which are long in a direction in which the position of the anchor can be adjusted.

6. The cryogenic tank according to claim 4,
wherein a position of the anchor of the membrane anchor mechanism can be adjusted, and
wherein an outer shape and a central opening of the interposition part are formed in elliptical shapes which are long in a direction in which the position of the anchor can be adjusted.
